(19) United States
(12) Patent Application Publication
(10) Pub. No.: US 2009/0188287 A1
(43) Pub. Date: Jul. 30, 2009

(54) Axial spring balancing pin tumbler lock

(76) Inventors: Forrest Xu, West Covina, CA (US); Daniel Xu, West Covina, CA (US)

Correspondence Address: FORREST XU, 1818 FAIRGROVE AVE, WEST COVINA, CA, 91791, US

(21) Appl. No.: 12/011,789

(22) Filed: Jan. 30, 2008

(51) Int. Cl. E05B 27/08

(52) U.S. Cl. 70/358

(57) ABSTRACT

An axial pin tumbler lock including a shell comprising a plurality of chambers formed in a radial pattern around a circle; a rotatable plug containing a through hole for mounting a center post, a main bore for receiving a tubular key, a first plurality of chambers formed in a radial pattern around a circle on its front end and arranged in such a way that each one of the first chambers in the plug extends coaxially with a corresponding chamber on said shell, and a second plurality of chambers formed in a radial pattern around a relatively smaller circle on its rear end, disposed in the shell; a plurality of spring-loaded driver pins disposed in the chambers on said shell; a plurality of spring loaded balance pins disposed in the second chambers and a plurality of combination pins disposed in the first chambers of said plug and initially extended into the chambers on said shell under compound extension force of the balance springs and the driver springs when the plug is at its locking position.

### FILED OF THE INVENTION

The present invention relates to a locking device. More specifically, the present invention relates to an axial pin tumbler lock with unique pick-resistant mechanism that can not be easily unlocked by conventional lock picking or bumping approaches.

### BACKGROUND OF THE INVENTION

The axial pin tumbler locks, also known as tubular locks or “Ace” locks, were invented in last century and have been developed for many years. The following U.S. patents are believed to represent the prior and current state of the art:
U.S. Pat. Nos. 4,112,820; 4,621,510, 4,802,354; 5,018,376; 5,400,629; 5,544,512; 6,357,271 and 7,150,168.

As evidenced by these patents, a tubular lock generally includes a shell containing a plurality of first pin bores; a plug, rotatable within the shell, containing a plurality of second pin bores facing to the first pin bores on the shell; and a plurality of pin sets, each comprising a spring-loaded first pin and a second pin, in the prior state of the art. The locking mechanism is created by having each spring-loaded first pin that seated in the first pin bore on the shell extended into a corresponding second pin bore in the plug at their initial position so to span both the shell and the plug and block the plug from rotating. The second pins reside in the second pin bores in the plug for receiving and transferring external force and in turn moving their corresponding first pins away by a pre-determined distance from their initial position so to catch the shear plane between the shell and the plug. All second pins normally expose directly to the keyway with relatively bigger profile so that they are relatively easier to be accessed and manipulated by picking or bumping tools.

So far as we know, all the development tried to provide a relatively higher level of security within the prior state of the art of axial pin tumbler locking mechanism have not changed the core nature of double-pin-single-spring configuration. So the basic disadvantage of easily being picked open is not improved practically.

### SUMMARY OF THE INVENTION

It is the primary object of the present invention to provide an axial pin tumbler lock with an new pin tumbler spring configuration that is highly resistant to lock picking or bumping attempt.

It is another related object of the present invention to provide an axial spring balancing pin tumbler lock that is generally cost efficient to manufacture.

It is a further related object of the present invention to provide an axial pin tumbler lock that is easy to be assembled, mastered and serviced.

The foregoing mentioned objects and other objects of the present invention are achieved by providing an exemplary axial spring balancing pin tumbler lock with a new and unique pin tumbler spring configuration that improves the locking mechanism of the prior art by changing the “initial-on-duty” locking pin tumblers to the combination pins from the driver pins in the prior art, changing the driven force that moves the “initial-on-duty” locking pin tumblers to pre-determined internal forces from external key forces in the prior art, changing the “initial-on-duty” pins to being isolated from being exposed directly to the opening keyway in the prior art. By all those new approaches and more, the axial spring balancing pin tumbler lock of the present invention makes it extremely difficult to unlock the lock by means of conventional lock picking or bumping methods.

Overall, the foregoing objects and other advantages of the present invention will become more apparent from the following detailed description when taking in conjunction with the reference drawings.

### BRIEF DESCRIPTION OF THE DRAWINGS

The structure, features and functions of this invention are described in detail with reference to the following description together with the accompany drawings, in which:

FIG. 1 is a perspective view, quarterly sectioned and broken away, of an exemplary axial spring balancing pin tumbler lock and a tubular key of the present invention.

FIG. 2 is an exploded perspective of the lock in accordance with the present invention.

FIGS. 3a and 3b are isolated perspective views, quarterly sectioned and broken away and from different angle, of an exemplary housing used in the lock of the present invention.

FIG. 4a is an isolated perspective view, quarterly sectioned and broken away, of an exemplary plug used in the lock of the present invention.

FIG. 4b is a front view, partially sectioned and broken away along line II-II of the same part in FIG. 4a.

FIG. 5 is an perspective view of an spindle used in the lock of the present invention.

FIG. 6 is an axially sectioned view showing the locking mechanism of the present invention in case of no key engaged with the lock.

FIG. 7 is an axially sectioned view showing the unlocking mechanism of the present invention when a key with correct notches fully inserted into the keyway.

FIG. 8 is a perspective view, quarterly sectioned and broken away, of an exemplary housing sub-assembly used in the lock of the present invention.

FIG. 9 is a perspective view, quarterly sectioned and broken away, of an exemplary plug sub-assembly used in the lock of the present invention.

FIG. 10 is an axially sectioned view of a conventional axial pin tumbler lock.

FIG. 11 is an axially sectioned view showing the picking resistant features of the present invention.

### DETAILED DESCRIPTION OF THE INVENTION

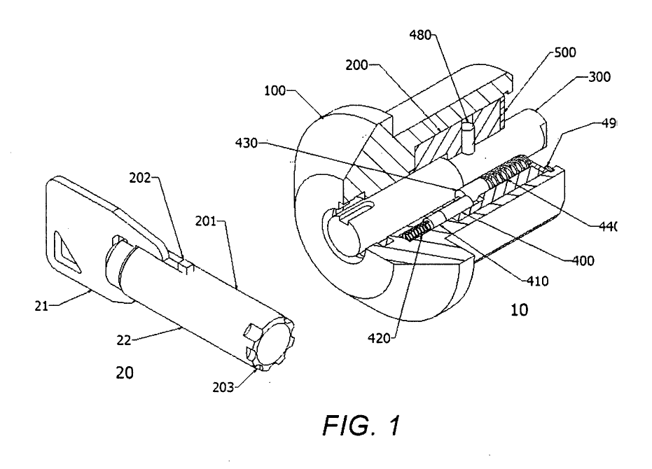

With reference to FIG. 1, an exemplary lock in accordance with the present invention comprises an axial spring balancing pin tumbler lock 10 and a tubular key 20 corresponding to the lock 10.

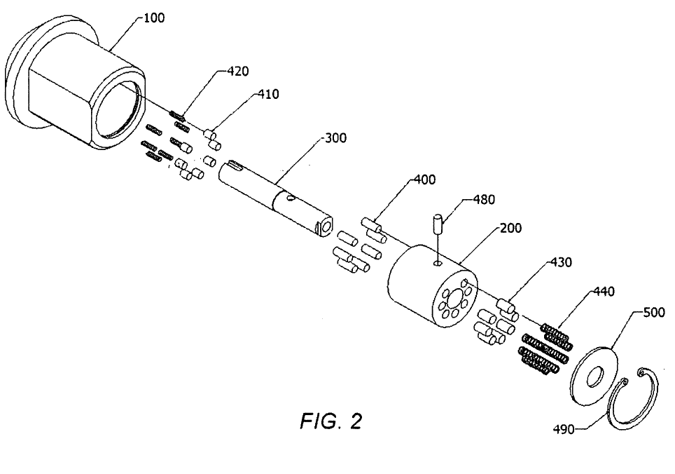

Referring to FIG. 2, the lock 10 comprises a shell 100; a plug 200, a spindle 300, a plurality of first pins 410 and first coiled compression spring 420, a plurality of second pins 430 and second coiled compression spring 440, a plurality of third pins 400, a retaining pin 480, a cover 500 and a retaining ring 490.

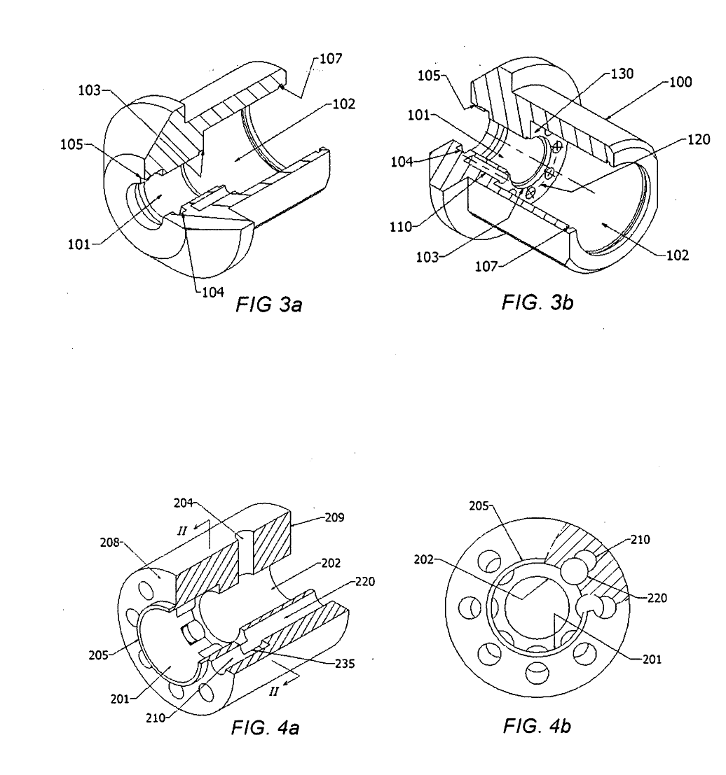

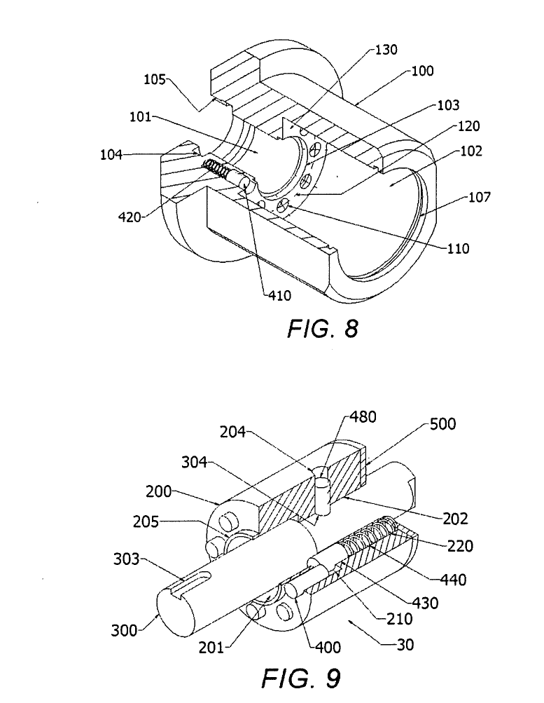

Referring to FIGS. 3a, 3b and 8, the shell 100 comprises a through hole 101, a main bore 102 coaxially defined on rear end, a shallow bore 103 coaxially defined on bottom surface 130 of the main bore 102, a first annular groove 104 defined on the through hole 101 near the front end, a second annular groove 107 defined on the main bore 102 near the rear end, a keyway 105 defined on front end communicating to the first annular groove 104, and a plurality of first pin bores 110 defined annularly and evenly along a pitch circle 120 on the bottom surface 130 of the main bore 102. The first coiled compression springs 420 and first pins 410 are disposed into the first pin bores as shown in FIG. 8.

Referring to FIGS. 4a and 4b, the plug 200 comprises a key bore 201 coaxially defined on front end 208, a through aperture 202, a locking pin hole 204 defined on outer cylindrical surface communicating to the through aperture 202, an annular collar 205 extended the key bore 201 on front end 208, a plurality of third pin bores 210 defined on the front end 208 with same depth of the key bore 201 and arranged such that each one of the third pin bores 210 extends coaxially with one of corresponding first pin bores 110 in the shell 100, a plurality of second pin bores 220, each is greater than the third pin bore 210 in diameter, defined annularly and evenly on the rear end 209 and arranged such that each one of the second pin bore 220 is radially and inwardly eccentric to its corresponding third pin bore 210 respectively and overlaps the key bore 201 and one of the corresponding third pin bores 210 radially and axially in the middle portion of the plug 200.

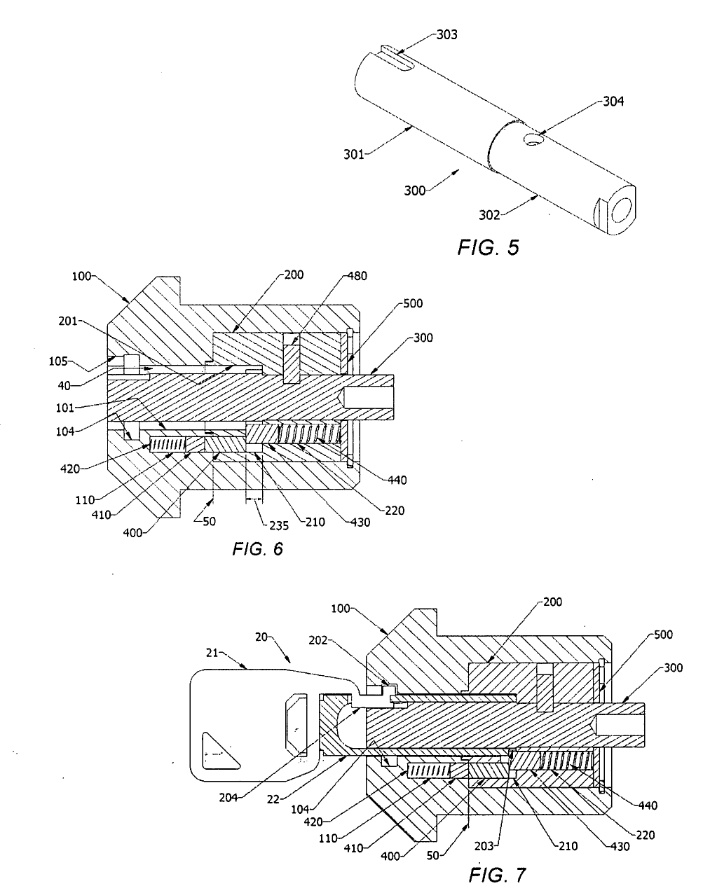

With reference to FIGS. 5 and 9, an elongated spindle 300 comprises a front portion 301, a rear portion 302 with smaller diameter than the front portion 301, a short axial groove 303 defined on the front end and a cutout 304 defined on the rear portion. The spindle 300 is fixedly engaged with the through aperture 202 in the plug 200 and is secured by a retaining pin 480. The third pins 400 are disposed into the third pin bores 210 in the plug 200. The second pins 430 and second coiled compression springs 440 are disposed into the second pin bores 220 in the plug 200 as shown for receiving their corresponding third pins 400 and tubular key notches 203. The cover 500 fixedly attaches to the spindle 300 and abutted against the rear end 209 of the plug so to retain the second pins 430 and second coiled compression springs 440 within the second pin bores 220. The plug sub-assembly 30 is then disposed into the main bore 102 of the shell 100 in such way that the front end 208 of the plug 200 mating to the bottom surface 130 of the shell 100 and is retained by a internal retaining ring 490 so to prevent the plug sub-assembly 30 from moving outwardly.

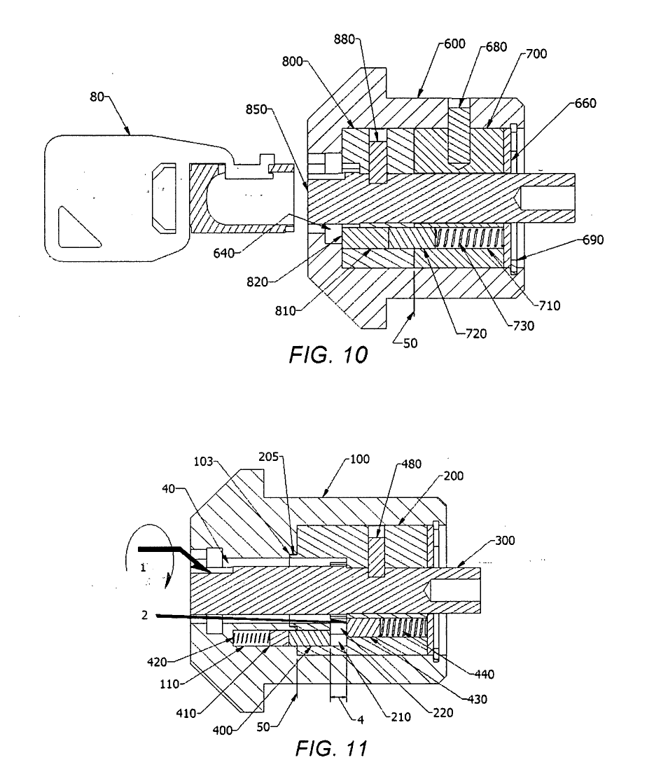

Referring to FIGS. 1 and 10, the key 20 used in the present invention is quite similar to a tubular key 80 in the prior art except that the key 20 has an elongated tubular portion 201 between the lug 202 and the notches 203.

The through hole 101 in the shell 100 and the key bore 201 in the plug 200 have exactly the same diameter. The through hole 101, the key bore 201 and the spindle 300, when they are assembled, constitute a tubular keyway 40 for receiving tubular key 20.

Referring to FIGS. 6, 7 and 11, the locking and unlocking mechanism of an exemplary axial spring balancing pin tumbler lock of the present invention is described further below: is descried further below.

As has been described in detail in above sections, an exemplary lock in accordance with the present invention utilizes a plurality of pin spring set, each comprising three pins 410, 400 and 430 that are sandwiched between a pair of coiled compression springs 420 and 440 along their pin bores 110, 210 and 220 respectively. Among those components, the third pin 400 and the first pin 410 have the same size in diameter so they can slide into each other resident pin bore in operation. The second pin 430 is greater than first pin 410 in diameter. The extension force of the second coiled compression spring 440 at its preloaded length is greater than that of the first coiled compression spring 420 at its fully loaded length. When there is no key engaged, all second pins 430 and third pins 400 are urged by the compound extension force of the first coiled compression springs 420 and the second coiled compression springs 440 to their most extended position while all first pins 410 are urged to their most retracted position. The third pins 400 are the combination pins of the locking mechanism so their lengths vary. The shortest third pin 400 is such long that its front end is flush to the front end 208 of the plug 200 when it is at its most extended position and the longest is such long that its front end is flush to the front end 208 of the plug 200 when it is at its most retracted position. The length varying range of the third pins 400 is defined by the axially overlapped distance 235 of the second pin bores 220 and the third pin bores 210 in the plug 200. The mating surface of the plug 200 and the shell 100 constitutes a shear plane 50 of the locking mechanism of the lock 10 of the present invention. When there is no key or external picking attempt engages, all or some of the third pins 400 extend into their corresponding first pin bores 110 in the shell 100. The extended third pins 400 bridge the shear plane 50, the plug 200 is therefore blocked from rotating.

FIG. 7 shows the unlocking mechanism of the present invention in case that a key 20 with correct notches 203 fully inserted into the keyway 40. Each notch 203 with correct length properly depresses the second pin 430 away from its initial position and it, in turn, deforms the second coiled compression spring 440 to such a length that it just allows the front end of the third pin 400 to coincide with the shear plane 50 by the new compound extension force of the second coiled compression spring 440 and the first coiled compression spring 420, the plug 200 is therefore free to rotate within the shell 100.

If a key 20 with incorrect notches 203 is inserted into the keyway 40, the notches 203 and the extension force of the first coiled compression springs 420 cause the pins 430, 400 and 410 to move together to such new position that the front end of each third pin 400 is either fallen into the third pin bore 210 in the plug 200, thus its corresponding first pin 410 will bridge the shear plane 50, or is still remaining in the first pin bore 110 in the shell 100 then the third pin 400 will bridge the shear plane 50. No matter which scenario occurs, the plug 200 is blocked from rotating within the shell 100.

With regarding to the picking-resistant features that the present invention pertains, FIG. 10 to 11 illustrated how it works in some typical situation of conventional lock picking attempts.

As illustrated in FIG. 10, a conventional pin tumbler lock 60 typically contains only one group of coiled compression springs and two groups of pins. A group of first pins 720 and first coiled compression springs 730 reside in a group of first pin bores 710 in a stationary plug 700 which is fixedly anchored to the shell 600. A group of second pins 820 reside in a group of second pin bores 810 in a rotatable plug 800 and is partly exposed to the keyway 640. The first pins 720 are extended into their corresponding second pin bores 810 in the rotatable plug 800 so to bridge the shear plane 50 and block the rotatable plug 800 from rotating about the stationary plug 700. To pick a conventional axial pin tumbler lock, it needs to apply a rotation torque to the rotatable plug 800 first and to employ a picking tool to tentatively depress a selective second pin 820 and to find a skewed corresponding first pin 720, then further depress it down until getting a feeling that the other end of the second pin reaching the shear plane 50. This picking method in the prior art will not work on this new lock of the present invention.

As shown in FIG. 11, when a rotation torque 1 is applied to the spindle 200 then a picking tool 2 is inserted into the keyway 40 to depress one selected second pin 430 down as it normally does in the prior art for a picking attempt, the third pin 400 associated with the second pin 430 will be skewed by the misaligned bores 110 and 210 due to the inevitable tolerance among the components at its initial position. Depressing or hitting the contacting second pin 430 further by a pick or bumping tool 2 through the keyway 40 will cause the second pin 430 to be separated from its mating third pin 400 and a gap 4 will be produced. Since the third pin 400 is isolated from the keyway 40, there is no way to pull or push the third pin 400 moving back to the third pin bore 210 except with the extension force of the first coiled compression spring 420. However, that force is too small to overcome the pin skewing friction. A sudden release of the tool 1 may help the skewed third pin 400 moving, but the moving distance is not controllable, and the picking or bumping attempts must fail.

As shown in FIG. 11, an exemplary lock of the present invention has a coupling arrangement: an annular collar 205 defined on front end 208 of the plug 200 mates a shallow bore 103 coaxially defined on the bottom surface 130 of the main bore 102 in the shell 100. This structure constitutes two straight angle turns about the tubular keyway 40 so to prevent the third pins 400 from being accessed or measured by a picking tool.

We claim:

1. An axial spring balancing pin tumbler lock, comprising:
a shell comprising a through hole and a main bore with enlarged diameter on an end for receiving a plug;
a plug, rotatably disposed within the shell, containing a through hole therein for receiving a post in the center and an enlarged key bore on rear end for receiving a tubular key insertion;
a post, containing an axial defined slot on its front end, disposed in the plug and mounted rigidly with the plug by means of a set screw anchoring;
a plurality of chambers in a radial pattern formed around a circle on bottom surface of the main bore on said shell for receiving spring-loaded driver pins;
a first plurality of chambers in a radial pattern formed around a first circle on front end of the plug for receiving combination pins and arranged such that each one of the first plurality of chambers extends coaxially with a corresponding one of said chambers on the shell when the plug is in its first rotational orientation relative to the housing;
a second plurality of chambers in a radial pattern formed around a second relatively smaller circle on rear end of the plug for receiving spring-loaded balance pins such that the second chambers partially overlapped with both the key bore and a corresponding first chamber in the middle portion of the plug;
a plurality of spring-loaded driver pins, each comprising a coiled compressing spring and a driver pin, disposed in said chambers on the shell in such a way that each driver pin is able to slide into said first chambers on the plug respectively in case that they are aligned to each other;
a plurality of combination pins, each comprising a top end and a bottom end, disposed in said first chambers on the plug and had their top end extended into said chamber on the shell respectively in case that they are aligned to each other respectively;
a plurality of spring-loaded balance pins, each including a coiled compressing spring, a balance pin with a top end and a bottom end, disposed in said second chambers and sealed by a cover or by a plurality of covers respectively on the plug in such a way that a portion of the top end surface of said balance pin contacting a portion of said bottom end surface of said combination pin so to cause a portion of a corresponding said combination pin slidably extended into said chambers on the shell under the compound extension force of the balance spring and the driver spring;
a tubular key including a turning handle, an external square lug, an internal key, and a plurality of notches on its free end, each configured and dimensioned to press its corresponding said balance pin of the lock.
said driver pin having same size in diameter with said combination pin but said balance pin having greater size in diameter than said combination pin;
said balance spring having greater extension force at its pre-loaded length than that of said driver spring at its fully loaded length respective so that the top end surface of said balance pin contacting the bottom surface of said second chamber and the end surface of said combination pin simultaneously at their initial position, i.e. no said tubular key or any external force engaged;
a mechanism for locking the lock by foregoing initial setting or for unlocking the same by a full insertion of said tubular key that depresses all balance pins to away to a varied necessary distance from their initial position respectively so to allow all the top surface of said combination pins to be moved back to collinear with the shear plane under a compound extension force of said balance spring and said driver spring.

2. A locking mechanism in an axial pin tumbler lock, embodied by:
a housing containing a main bore for receiving a plug and at least one blind pin bore formed on the bottom surface of the main bore for receiving a driver pin set;
a plug rotatably disposed within said housing in such a way that its front end collinear to the bottom end surface on the housing so to constitute a shear plane, containing a opening for receiving a key insertion, at least one first blind pin bore formed on its front end and arranged such that it may extend coaxially with said pin bore on said housing when the plug is in its first rotational orientation relative to the housing, and at least one second blind pin bore formed on its rear end and arranged such that the second pin bore is eccentric to the first pin bore and is overlapped with both the second pin bore and said opening in the middle of the plug;
a spring-loaded driver pin set, each containing a driver pin and a coiled compressing driver spring, disposed in the pin bore on the housing in such a way that one end of said driver spring seated on the bottom of the pin bore and the other end of said driver spring contacted said driver pin;
a spring-loaded balance pin set, each containing a balance pin, a coiled compressing balance spring that it has greater extension force at its preloaded length than that of driver spring at its fully loaded length, a float pin and a cover, disposed in the second pin bore on the plug in such a way that the top end of said balance pin seated on the bottom of the second pin bore, the bottom end of said balance pin contacted said balance spring and said float pin simultaneously, and said cover sealed the second pin bore rigidly;
a combination pin disposed in the first pin bore on the plug in such a way that its bottom end contacted the top end of the balance pin and its top end extended into the pin bore on the shell under the initial compound extension force of opposite disposed balance pin set and driver pin set and may move back into the first pin bore on the plug in case of the compound extension force change;
a compound extension force may be changed by applying an external force onto the top end of the balance pin with a key or other means;
said plug may be free to rotate under such a compound extension force that caused the top end of the combination pin collinear to the shear plane.

3. The axial spring balancing pin tumbler locking mechanism according to claim 1, an annular collar coaxially extruded on the front end of said plug mating with a bore coaxially formed on the bottom of said main bore on the shell so to block any attempt of accessing the shear plane by picking tools.

4. The axial spring balancing pin tumbler locking mechanism according to claim 1, a plurality of float pins with a length greater than the fully loaded length of said balance spring disposed in said second chambers on the plug inside each said balance spring respectively so to protect the spring to be damaged.

5. The axial spring balancing pin tumbler locking mechanism according to claim 1, an annular groove on the center post functioned as an over-the-torque joint comprising an axial slot on its first end, on the first longitudinal half portion near the first end, and a shallow hole or a bit of flat on other longitudinal half portion.

6. The axial spring balancing pin tumbler locking mechanism according to claim 1, a plug rotating angle constrain mechanism comprising a dowel pin disposed in a hole defined axially on outer edge of the main bore on said plug and exposed out of the rear end of said plug, another dowel pin disposed in a hole axially defined on outer edge of the main bore on said shell at such a position that it is apart radially from its zero degree about the axial direction of said shell by a pre-determined angle allowing said plug rotating, a shell plate with a circumferential should on an end covering said plug and said dowel pins, and a retaining ring disposed in an annular groove on the main bore of said shell to block all installed component inside said shell from moving outwardly.
